(19) United States
(12) Patent Application Publication
(10) Pub. No.: US 2017/0316560 A1
(43) Pub. Date: Nov. 2, 2017

(54) Visual Jig and Related Methods

(71) Applicant: Automated Industrial Machinery, Inc., Addison, IL (US)

(72) Inventors: Constantine Grapsas, Oak Brook, IL (US); Dustin Kimble, Lombard, IL (US)

(21) Appl. No.: 15/498,686

(22) Filed: Apr. 27, 2017

Related U.S. Application Data
(60) Provisional application No. 62/328,425, filed on Apr. 27, 2016.

(51) Int. Cl. G06T 7/00; H04N 9/31; G06T 7/73

(52) U.S. Cl. CPC G06T 7/0006; G06T 7/73; H04N 9/3188

(57) ABSTRACT

A method of inspecting a part comprising projecting a life sized image of at least one portion of a selected part file onto a flat surface with a projector, placing a part adjacent to the flat surface, comparing the part to the life sized image of the at least one portion of the selected part file, receiving at least one command at a user interface to modify the life sized image such that it matches the part, and adjusting a manufacturing process based on the at least one command using a control system.

### RELATED APPLICATIONS

This application claims the benefit of U.S. Provisional Application No. 62/328,425 filed Apr. 27, 2016, which is hereby incorporated by reference in its entirety.

### TECHNICAL FIELD

This invention relates generally to part inspection systems, and more particularly to an apparatus to aid in inspecting parts during the manufacturing process.

### BACKGROUND

Various part inspection systems are known in the art. Such systems include physical jigs, such as squares, which can be used to measure bends or corners. Optical comparators are known to project a magnified silhouette of a part on a screen, allowing for comparison to a template of the part. Modern inspection systems include devices that capture a digital photo or video of a part and compare it to a digital image of either a sample part or of a computer generated model. These devices are typically designed for automated inspection, requiring significant programming to inspect each part.

There are several additional problems associated with these existing designs. Physical jigs and automated inspection systems lack flexibility to inspect different part designs. These systems typically provide a pass/no-pass result, with no way to measure the amount of error in a given part. In addition, photos captured in an automated camera system are generally taken from a single angle as the part moves along the production line. Images captured in this way might miss errors that are masked by the orientation of the part. Optical comparators are designed for use with small parts that require magnification to identify and measure defects. None of these systems are designed to easily measure the amount of deviation from the part design to the physical part. These systems also lack a feedback loop beyond simply rejecting the parts, so that a poorly programmed machine tool can continue to create parts having the same defect.

In light of these disadvantages in the known part inspection systems, there is a need for a part inspection system that allows a user to compare a computer generated template to the physical part from multiple angles, and which automatically updates the commands sent to the manufacturing tools to correct for measured error.

The needs discussed above are particularly relevant in parts manufactured through wire bending operations. Automated wire bending machines are used to create accurate and complex bends in a variety of materials, cross-sectional shapes, and sizes. Automated wire bending machines may be operated, for example, through computer numerical control (CNC). CNC wire bending machines allow a user to design a shape using a computer or other processing device, and have the machine create the shape consistently according to a part program. By automating the wire-forming process, complicated parts can be made beyond the capabilities of ordinarily skilled human craftsmen. Further, CNC wire bending machines may be used to create precise parts repeatedly, reducing the need to inspect or rework individual parts. For instance, the creation of wire grocery carts requires many precise bends which are not easy to manually execute.

A variety of automated wire benders are known in the art. These include two-dimensional machines, in which the finished wire is substantially flat because each bend forms the wire in a single plane; and three dimensional machines, in which the finished wire is more complex and may have bends defining multiple planes in space.

Certain automated wire benders known in the art use LRA file structures to define wire parts. In addition to other information, these files comprise a sequence of values that define a length of wire to feed, a rotation indicating the plane of a bend, and an angle for the bend. The LRA file may also include offsets associated with the bend, which adjust the commanded bend based on actual parts fabricated on the wire bender.

Bend angle offsets accommodate a variety of physical variations in the wire. For example, to form a particular angle in a wire, the wire must be bent farther than the desired bend angle. Persons skilled in the art describe this extra bending as “overbend.” The phenomenon may also be described as “springback” because the wire springs back when a bending force is released. In view of this physical phenomenon, when defining bend angles for an automated wire bending machine, the machine must factor in a predetermined amount of overbend for each of the programmed bend angles. The amount of overbend may vary based on material properties, cross-sectional shape, diameter, bend angle, bend radius, and temperature. For example, the material properties or the diameter of a steel wire may vary significantly enough to affect part quality. This is particularly true for wires manufactured from lower quality and recycled steel. Thus, the overbend values may shift from batch to batch of wire.

In parts created on automated wire bending machines, a small error in the bending angle may create large errors in the overall shape of the part. In parts having multiple bends, it may be difficult to isolate an individual bend that causes errors in the part as a whole, because misalignments related to the individual bend may appear to have been created by other bends. This is particularly true in three-dimensional parts, where the geometry of the part may be complicated and difficult to visualize.

### SUMMARY

Generally speaking, pursuant to these various embodiments, a control system is coupled to a projector to project a life-sized image of a part or portion of a part onto a flat surface. A user then places the physical part adjacent to or on the flat surface and measures the difference between the actual part and the projected image. A user interface allows the user to input the measured errors into the control system. The control system then amends the commands sent to the machine tools used to manufacture the part to correct for the error.

### BRIEF DESCRIPTION OF THE DRAWINGS

The above needs are at least partially met through a visual jig system and methods of use described in the following detailed description, particularly when studied in conjunction with the drawings, wherein:

FIG. 1 comprises a view of the visual jig system.

FIG. 2 comprises a sample user interface for use with the visual jig system of FIG. 1.

FIG. 3 illustrates the calibration of the visual jig system of FIG. 1.

FIG. 4 illustrates a part being inspected with the visual jig system of FIG. 1.

FIG. 5 is a flow diagram of a method of using a visual jig system.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

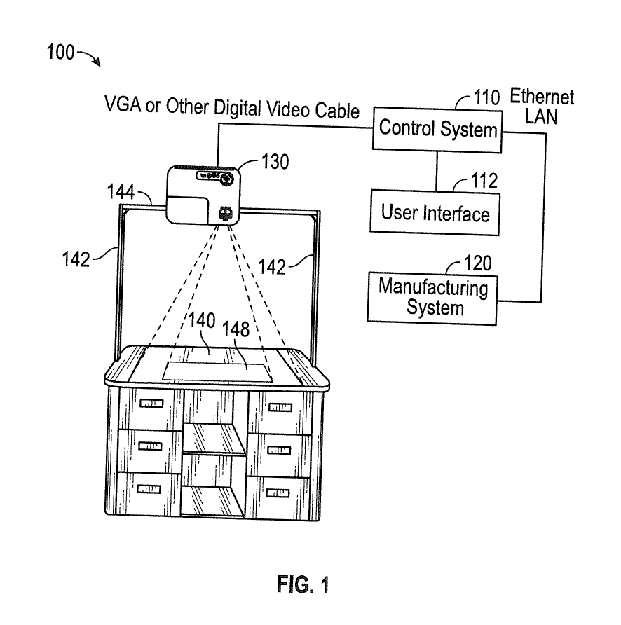

Turning to the figures, a visual jig system 100 for inspecting parts according to an embodiment of the present invention is shown in FIG. 1. The visual jig system 100 includes a control system 110 in electronic communication with a projector 130 and a manufacturing system 120. The projector 130 is configured to project images onto the surface 140. In the present embodiment, the surface 140 is a horizontal table top on which a part can be placed. The projector 130 is disposed above the surface 140 such that the optical axis of the projector 130 is substantially perpendicular to the flat surface 140 so that images projected onto the surface 140 are minimally distorted. Preferred embodiments of the invention will include a projector with minimal optical distortion, meaning for example that the magnification of the part projection remains substantially the same from the optical axis to the corners of the projected image. In alternatively preferred embodiments, the image provided to the projector will correct for any optical distortion present in the projector. The manufacturing system 120 comprises one or more machine tools operable to create the parts being inspected by the visual jig system 100. For example, in a preferred embodiment, the manufacturing system 120 comprises an automated wire bending machine used to form parts to be inspected by using the visual jig system 100. In the present embodiment, the machine tools are directly controlled by the control system 110. In alternative embodiments, the manufacturing system 120 is a remote system that receives a data output from the control system 110 representing error measured during the inspection process.

The control system 110 is coupled to a user interface 112. In alternative embodiments, the user interface 112 may be included as part of the control system 110. The user interface 112 is configured to display information to the user and take commands from the user. In the present embodiment, the user interface 112 comprises a standard monitor, keyboard, and mouse such as those used with a personal computer. In alternative embodiments, the user interface 112 can comprise a touch screen, a key pad, a trackball or trackpad, or simply a few buttons. In other alternative embodiments, the user interface 112 comprises a separate computer, smartphone, or tablet device in communication with the control system. The control system 110 further includes a memory unit (not separately illustrated) on which part files and software are stored. The memory unit can comprise an internal hard drive or flash memory and can further include an external memory device such as a server or computer in communication with the control system such that part files can be remotely accessed by the control system 110.

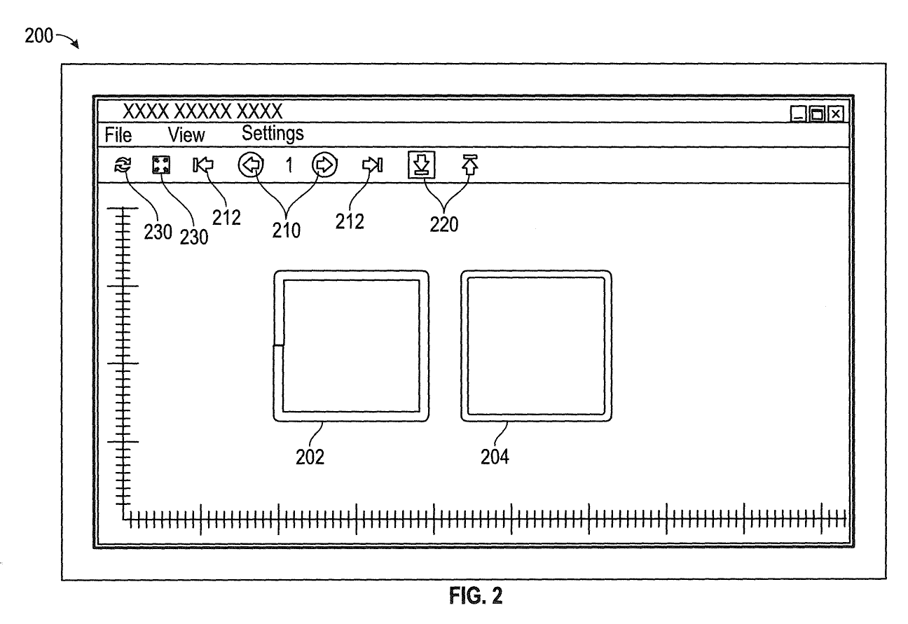

FIG. 2 illustrates the image projected on the horizontal surface 140 of the visual jig system 100, along with a graphical user interface (GUI) of software 200. In alternative embodiments, the GUI may also be shown on a user interface 112 of the control system 110 for use with the visual jig system 100. FIG. 2 also illustrates a part 202 placed on the horizontal surface 140. The software 200 displays a model 204 of a part loaded in from a part file. A part file is a 3D representation of a part created in a 3D modeling software or in a machine tool control software. The part file is preferably be an LRA file, which defines the length of each wire segment, the angle of each bend, and the relative rotation of the bending head for each bend. In alternative embodiments, the software 200 is programmed to read parts files types created in existing programs, including but not limited to .lra, .dxf, .3ds, .dae, .fbx, .ipt, and .cgr. The software 200 converts the part file into a 2D line drawing 204. The line drawing 204 is what is sent to the projector 130 to be projected onto the surface 140.

The software 200 can be configured to display the part incrementally by displaying each additional feature, such as a bend, one at a time. This feature is particularly advantageous with respect to parts manufactured by bending wire, because partially formed parts may be inspected. An individual bend having an error is thus easily identified. By contrast, when inspecting fully formed wire parts it is often difficult to identify the source of error that causes a misformed three dimensional part. The left and right arrow keys 210 allow the user to cycle between the features. The software further includes first and last keys 212 that allow the user to skip to the beginning or the end of the list of features.

The software 200 further allows for the user to view the model 202 from multiple views. The up and down arrows 220 toggle between standard views, such as top, front, bottom, and back. The image manipulation selection 230 allows for the user to adjust the size and orientation of the model so that it can be viewed from any angle. The software 200 creates a line drawing 204 of the part, e.g., the shown part 202, from whatever angle is selected in the GUI, which can then be projected onto the surface 140 to compare to the physical part.

In addition to the tool bar shown in FIG. 2, the commands described above can be controlled by other user inputs such as a keyboard. For example the arrows 210 and 220 can be mapped to a direction pad on a keyboard or keypad, this allows the user to more quickly move between features and views while inspecting a part. In alternative embodiments, the software 200 can be set to cycle between features and/or views at set intervals of time so that parts can be inspected without having to continuously provide user inputs.

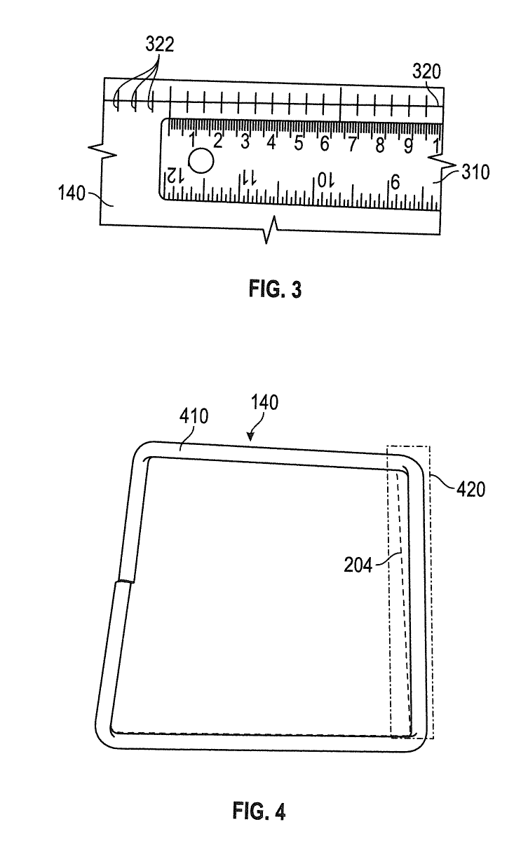

In operation, the image projected onto the surface 140 needs to be life sized so that it can be used as a visual jig to measure error in the part being inspected. FIG. 3 illustrates the surface 140 during calibration of the visual jig system 100. For calibration, the control system 110 displays test image such as a graphical image of a ruler 320 onto the surface 140 using the projector 130. The user then measures the distance between the displayed hatch marks 322 using a physical measuring device 310. The measured distances are input into the control system 110 via the user interface 112, and the control system adjusts the size of line drawings 204 projected onto the surface based on the measurements from calibration and the stored measurements in the part file in order to create a life sized image. In alternative embodiments, the user can adjust the projector 130 during calibration to make the graphical image of a ruler 320 projected onto the surface 140 a certain size. The projector 130 can be adjusted by moving it relative to the surface 140, adjusting one or more lenses, and/or using an integrated digital zoom feature.

Once calibrated, the visual jig system 100 can be used to inspect a part as shown in FIG. 4. In FIG. 4, the line drawing 204 is projected onto the surface 140 by the projector 130. A part 410 is then placed on the surface 140 and aligned with the line drawing 204. Any type of part can be inspected using the visual jig system 100 described herein. Example parts include but are not limited to bent wire parts, bent tubing parts, milled parts, extruded parts, and lathed parts. The part 410 illustrated in FIG. 4 is a bent wire part. As can be seen the majority of the part 410 matches the line drawing 204 so that no portion of the drawing 204 is visible off of the part 410 on 3 sides. FIG. 4, however, illustrates a part having a defective area 420 in which the part does not perfectly match the visual jig created by the projection of the line drawing 204. Specifically, the dashed line showing the boundary of the line drawing 204 appears at a different angle than the corresponding portion of the bent wire part 410. This different angle illustrates an error in the defective area 420 that could be corrected by adjusting the bend angle for the corresponding bend in the part file.

In some embodiments, the user can measure this error using a physical measuring device 310 and input the error into the control system 110 using the user interface 112. The software 200 amends the line drawing 204 to match the measured error so that the user can ensure that it was correctly measured and input by comparing the new drawing 204 to the part 410 on the surface 240. In alternative embodiments, the user interface 112 includes a first button for increasing and a second button for decreasing the most recent bend angle illustrated in the part drawing 204. By comparing the adjusted drawing 204 to the part 410 on the surface 240, a user can effectively capture the actual bend angle. The software 200 then amends the part file to reflect the error. The part file may be adjusted by providing offset values (e.g. to adjust the amount of springback observed in the wire) that are subsequently added within the machine control to the commanded bend angles, or by adjusting the values of the commanded bend angles themselves. The control system 202 adjusts the commands sent to the machine tools used in the manufacturing system 120 to correct for the measured error.

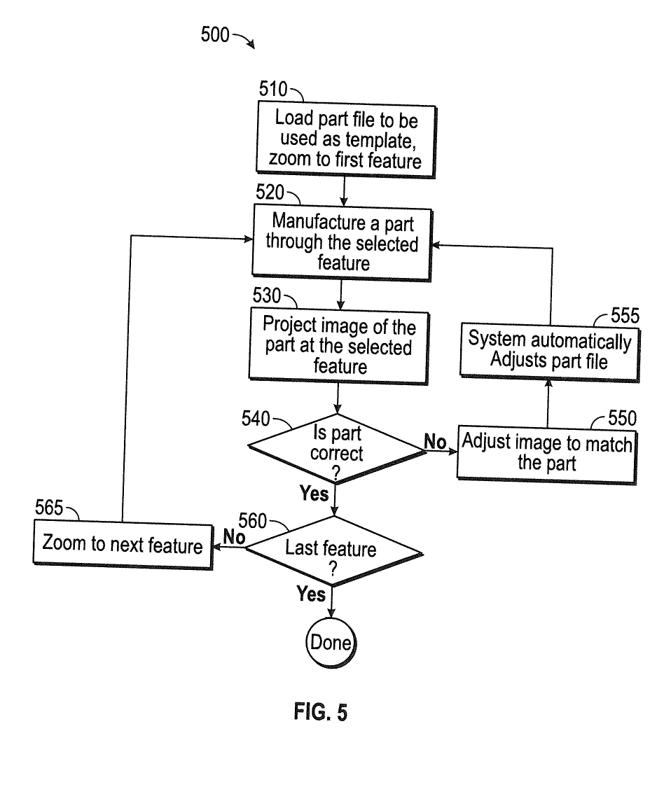

FIG. 5 is a flow diagram 500 illustrating a method of use of the visual jig system 100. In step 510, a part file is loaded into the control system 110. The control system 110 identifies a portion of the part file required to manufacture a part having a first feature or step, such as a bend. As a part of step 510, the control system may create a line drawing of that portion. In step 520, the control system operates one or more machine tools 120 to create a part at least through the displayed feature or step. In some embodiments, the order of steps 510 and 520 can be swapped, with the part being partially or entirely manufactured before it is loaded into the visual jig software. In the next step 530, the line drawing 204 of the first feature is projected onto a flat surface, such that the image on the surface is life sized, creating a visual jig. Steps 510, 520, and 530 occur substantially automatically, as defined by software running within the control system 110. In step 540, a user compares the projected image to the physical part created in step 520 to determine if the part matches the image. If the part has no error, the user inputs that the part is correct. If the part has error the user inputs the error measured into the control system or alternatively modifies the commands in the part file, by one of the methods described above. When the error or modified command is input, the control system 110 adjusts the image to match the actual shape of the part in step 550. The system then automatically adjusts the part file which changes the commands sent to the machine tool or machine tools to correct for the error in step 555. In alternative embodiments, steps 550 and 555 are combined such that the user directly edits the part file using an interface associated with the control system 110 for the machine tool. The commands adjusted vary based on the type of part being inspected. For example, when error is measured in a bent wire part, at least one bending angle parameter in the part file is changed. The inspection portion of the process starts over at step 520 when a new part is then created based on the updated part file.

When no error is measured in step 540 the control system determines if there are other features yet to be inspected in step 560. If not, then the inspection is complete. If the part file includes other features, the control system 110 in step 565 identifies a next portion of the part file required to manufacture a part having a subsequent feature or step, such as a bend. In some embodiments, the part is returned to the manufacturing system so that it can be manufactured through the next step or feature in step 520 and the process starts over. In alternative embodiments, the step 520 simply manufactures each step or feature up to and including the selected step or feature. The steps 520, 530, 540, 550, 555, 560, and 565 repeat until every step or feature of the manufacturing process is completed without any measured error.

In an alternative embodiment, the entire part is fabricated before inspection rather than one step at a time. Step 565 leads back into step 530, as the next step has already been manufactured. Step 555 leads to step 560 and a new part is not created until every feature has been inspected. Once the inspection is complete, a second part is created based on all of the changes made in step 555 throughout the first inspection, and it is in turn inspected by the process 500.

In addition to the above-mentioned embodiments, it should be understood that a variety of methods are also disclosed herein. For example, these additional methods include a method of setting up and calibrating the visual jig system, methods of manufacturing the devices described herein, and methods of manufacturing parts including visual inspection. These and other methods related to the subject matter set forth herein are intended to be covered by this disclosure. It should also be understood that while certain features have been described with certain embodiments, these features may be intermixed or interchanged with one another to form other embodiments as desired. All features disclosed herein are intended to be used in any of the embodiments disclosed herein either in lieu of similar features or in combination with other features.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. This will also be understood to encompass various combinations and permutations of the various components that have been set forth in these teachings.

What is claimed is:

1. A method of inspecting a part comprising:
projecting a life sized image of at least one portion of a selected part file onto a flat surface with a projector;
placing a part adjacent to the flat surface;
comparing the part to the life sized image of the at least one portion of the selected part file;
receiving at least one command at a user interface to modify the life sized image such that it matches the part; and
adjusting a manufacturing process based on the at least one command using a control system.

2. The method of claim 1, further comprising performing at least one bending operation on a wire to generate the part based on the at least one portion of the selected part file.

3. The method of claim 2, wherein projecting the life size image of the at least one portion of the selected part file further comprises projecting an image of each of a plurality of bends one at a time.

4. The method of claim 1 wherein the adjusting a manufacturing process further comprises changing at least one bending angle parameter in the part file based on the at least one command.

5. The method of claim 1 wherein the adjusting a manufacturing process further comprises changing one or more offset values in the part file based on the at least one command.

6. The method of claim 1, wherein the flat surface is a horizontal surface.

7. The method of claim 1 further comprising calibrating the projector, the calibration including:
projecting a test image onto the flat surface;
measuring the size of the projected image;
inputting the measured size into the control system;
comparing the measured size to an expected size; and
adjusting one of the projector and the life size image based on the difference between the measured size and the expected size.

8. A device for inspecting parts, the device comprising:
a control system comprising a memory unit, a processor, and at least one user input device, the memory unit capable of storing at least one part file, and the processor capable of generating an image of a part from the part file;
a horizontal flat surface configured to hold a physical part;
a projector disposed above the horizontal flat surface and oriented such that an optical axis of the projector is substantially perpendicular to the horizontal flat surface, the projector in electronic communication with the control system such that the projector is configured to project a life sized display of the image of a part onto the horizontal flat surface.

9. The device of claim 7, wherein the part is a wire with at least one bend.

10. The device of claim 8, wherein the user input device is capable of commanding the control system to generate the image of a part with a selected at least one bend chosen from a plurality of bends in the part file.

11. The device of claim 7, further comprising:
at least one machine tool;
wherein the control system further comprises a data output coupled to the machine tool such that a revised part file may be transmitted to the at least one machine tool.
